(19) United States
(12) Patent Application Publication
(10) Pub. No.: US 2011/0231271 A1
(43) Pub. Date: Sep. 22, 2011

(54) METHOD AND APPARATUS FOR PRESENTING ARTICLES OF CLOTHING AND THE LIKE

(75) Inventor: Pietro NEGRA, Fidenza (IT)

(73) Assignee: CRIS CONF S.P.A., FIDENZA (IT)

(21) Appl. No.: 12/728,434

(22) Filed: Mar. 22, 2010

(51) Int. Cl. G06Q 30/00; G06Q 50/00; G06F 17/30; H04N 7/14

(52) U.S. Cl. 705/21; 705/346; 707/758; 348/14.08; 707/E17.014; 348/E07.077; 705/27.1

(57) ABSTRACT

A method and an apparatus for presenting clothing products and/or the like at sales points (20) of a commercial network, comprising steps of predisposing a plurality of electronic terminals (21) in the various sales points (20), remotely connecting the electronic terminals (21) with a central electronic unit (11), creating a database for the products which is modifiable via the central electronic unit (11), and running a program on a computer which enables the central electronic unit (11) to receive from each electronic terminal (21) a query signal associated to at least a product on the database, to locate one or more further products in the database which can be combined with the product associated to the query signal, and to transmit a response signal associated to the further products to the electronic terminal (21) from which the query signal originated.

The invention relates to a method and an apparatus for presenting articles of clothing and the like at sales points of a commercial network for the clothes, mainly a commercial network comprising single-brand sales points.

As is known, one of the most widespread and consolidated sales strategies in the fashion sector is to sell clothing products and the like, for example scarves, handbags and other accessories, via a plurality of single-brand boutiques selling only the products of a single producer company.

Single-brand boutiques can be managed directly by the producing company or can be affiliated, in a franchising arrangement, i.e. managed by an independent owner depending on the marketing choices of the producing company.

One of the marketing choices made by the majority of fashion companies is to create two clothing collections each year, typically an Autumn-Winter collection and a Spring-Summer collection.

Some fashion companies also periodically update their collections during the season, by inserting new products which have the aim of keeping the interest of potential consumers at a high, and/or of following the latest fashion tendencies.

A further marketing choice of the majority of the fashion companies is to provide potential buyers not only with a wide range of products, but also a dressing style which usually takes the form of a series of recommendations as to how to combine various articles together, with accessories from the collection, so as to propose a total look.

The style choices are generally made by the producing company, with the help of a professional or a group of professionals, commonly known as stylists, who have the task of studying the products in the collection and their technical characteristics, carefully analysing fashion tendencies and the tastes of the reference client-base, and using the resulting analysis to define the best combinations to propose to the market, as a guideline to a total look. These proposals are then communicated to the sales personnel employed in the various boutiques. The sales staff will then have the task of coherently advising the final consumer.

At present, stylists' recommendations are communicated to the sales personnel in periodic updating courses normally held twice a year, typically when a new collection is presented.

Owing to the rapidity with which style tendencies can change, as well as to the possibility of additions of new products during the season, a more frequent updating of the sales staff vis-à-vis the characteristics of the collection, modes of use of the various articles and combinations to be made among them would be optimum, with an eye to achieving the desired total look.

This need is however at odds with the costs required for organising updating courses and with the loss of earnings that results from removing sales personnel from it normal work in the boutique; for these reasons it is difficult to reach an updating frequency which would keep the staff at the forefront of fashion.

An aim of the present invention is to resolve or at least reduce this drawback. A further aim of the present invention is to attain the above-set objective with a solution that is simple, rational and relatively inexpensive.

These and other aims are attained by the characteristics of the invention as reported in the independent claims. The dependent claims delineate preferred or particularly advantageous aspects of the invention.

In more details, an embodiment of the invention makes available a method for exhibiting clothing products and the like at sales points of a commercial network.

The method comprises providing a plurality of electronic terminals in the various sales points, remotely connecting the electronic terminals with a central electronic unit, creating a database of the above-mentioned products which can be modified via the central electronic unit, and running, via computer, a program which enables the central electronic unit to receive from each electronic terminal a query signal associated to at least a product of the database, finding, in the database, one or more further products which can be combined with the product associated to the query signal, and transmitting a response signal associated to the further products to the electronic terminal from which the original query signal originated.

Thanks to this solution, a whole collection can be stored in the database, together with the detailed information relating to the possible combinations of each product with the other products in the collection, such that the processing program can automatically provide style and total-look advice.

The above-mentioned combinations can be centrally selected by company stylists, and can be stored in the database, such as to be immediately available to all sales points.

In this way, the sales staff will be able to consult the system in order to see and possibly pass on to their customers the advice relating to combinations, total look and style that have been designed directly at the producing company, which combinations have been created by top professionals, very aware of all fashion tendencies; thus fashion errors due to personal opinions will be avoided.

The products present in the database and the combinations stored therein can also be modified at any time, via the central processing unit, such as to be continually updated with respect to the collection and modifications thereto, and thus such as to be continually at the forefront of fashion tendencies.

The electronic terminals can also be used by the sales staff, and even by the customers.

In this way, the system can perform a double function, i.e. a training and constant-updating of the sales staff, and a “virtual assistant” function in relation to sales, which can help or even replace the sales personnel.

In an embodiment of the invention, the processing program enables the central electronic unit to collect, from the database, data relating to the constructional characteristics of the product associated to the query, and to transmit a response signal associated to the data to the electronic terminal from which the query signal originated.

The advantage of this embodiment is that it provides the personnel and/or possibly the final consumer with the data relating to the constructional characteristics of the various products in the collection.

The term constructional characteristics relates, for example, to data relating to materials used, the chemical-physical properties thereof, modes of manufacturing, and the like.

In a further embodiment of the invention, the processing program also enables the central electronic unit to find data in the database relating to the modes of use of the product which is associated to the query signal, and to transmit a response signal associated relating to the data to the electronic terminal from which the query signal originated.

The advantage of this aspect of the invention is to provide the sales personnel and/or potential consumer with information on the modes of use of the various products, which might possibly be updated in relation to the season or the new fashion tendencies.

The term “modes of use” relates, for example, to the information relating to the dressability of the article of clothing, how to wear it, climatic conditions or situations most suited to the wearing of the articles, and the like.

In a further aspect of the invention, the processing program can also enable the central electronic unit to find data in the database relating to the available assortment of the product associated to the query signal, and to send a response signal relating to the data to the electronic terminal from which the query signal emanated.

The advantage of this aspect of the invention is that is provides the sales personnel and/or the potential consumer with information relating to the available assortment of the various products in the collection which, naturally, can be updated on the basis of availability and changes to the collection.

By the expression “details on the assortment”, reference is made, for example, to the sizes available, colours, variations of a same article of clothing.

All the above-delineated aspects also have the advantage of enabling the system to perform a descriptive function of the products in the collection, as well as those which might be introduced during the course of the season.

The descriptive function can be useful both in the context of sales personnel training and in that of promotional activities addressed directly to the final consumer.

In a further embodiment of the invention, the processing program also enables the central electronic unit to generate a buying order for the product associated to the query signal.

With this solution, the system can completely replace the sales staff, enabling a buyer not only to select the product but also to buy the chosen product, which can be sent directly to the consumer's home after acquisition.

To this end, at least one or more electronic terminals are preferably equipped with a POS device with enables payments to be made, for example by use of bank cash cards, credit cards, debit cards and the like.

This aspect of the invention enables completely automatic sales points to be created, for example in airports.

In a further embodiment of the invention, the method comprises the possibility of realising a video-conference communication via the central electronic unit, and at least an electronic terminal.

This embodiment is particularly useful for personnel training, as it enables, for example, a distance updating course to be organised.

The method of the invention can be realised by an apparatus comprising a plurality of electronic terminals located in the various sales points, a central electronic unit connected remotely to the electronic terminals, a clothing (and the like) products database which can be modified via the central electronic unit, and a computer program which, when run on a computer, enables the central electronic unit to interact with the database according to the modalities delineated herein above.

Further characteristics and advantages of the invention will emerge from a reading of the following description, which is provided by way of non-limiting example, with the aid of the figure of the table of drawings.

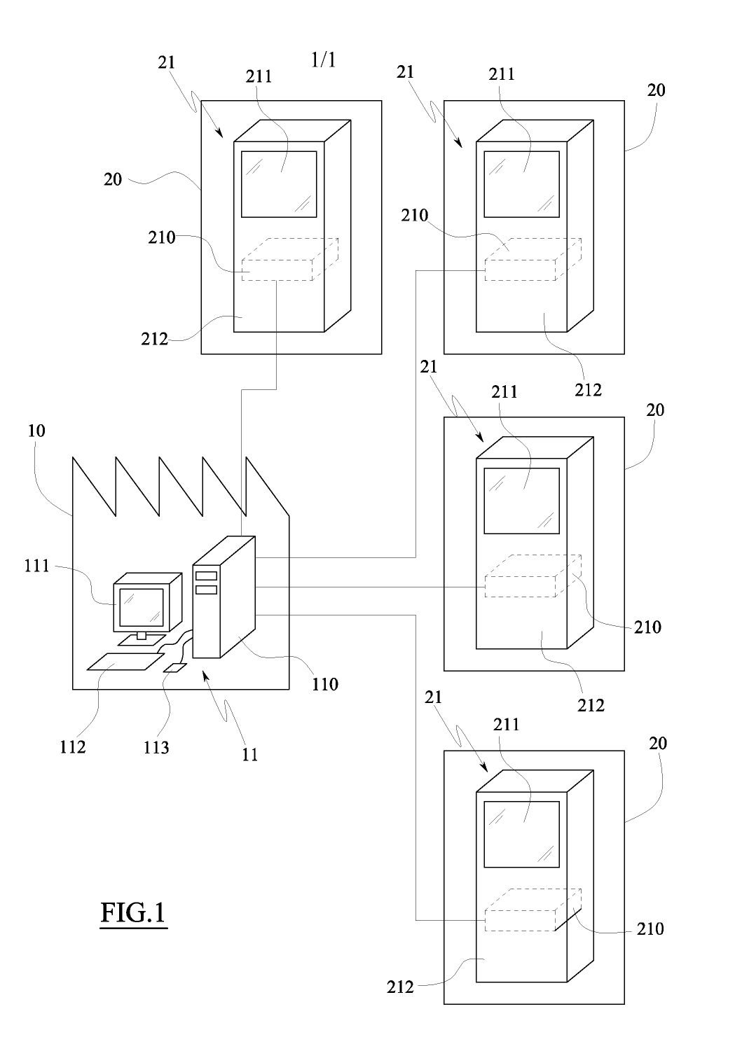

FIG. 1 is a schematic representation of a system for presenting clothing products and the like of the invention.

The system of FIG. 1 is a simple commercial network of a company producing articles of clothing and the like, which is denoted with reference number 10.

The commercial network comprises a plurality of single-brand sales points 20, commonly known as boutiques, which are located over a territory constituting the market of the producing company 10.

The boutiques 20 can be controlled directly by the producing company 10 or can be affiliated via franchising agreements.

An electronic terminal 21 is installed internally of each boutique 20, which can be made available to the sales personnel of the boutique 20 and/or to the customers entering the boutique 20.

The electronic terminal 21 comprises a computer 210 to which a touch-screen monitor 211 is connected, which enables each user to interact with the computer 210, i.e. it enables the computer 210 to exhibit data (output) to the user, in the present example in the form of visual elements on the monitor 211, and enables the user to supply data (input) to the computer 210, in the present example via the tactile panel associated to the monitor 211.

The computer 210 and the touch-screen monitor 211 are associated to a mobile container 212, which can have a pleasant aesthetic appearance and can be located internally of the boutique 20.

All the electronic terminals 21 are connected remotely to a single central electronic unit 11, which is located in the producing company 10 or in any case in a place relating thereto.

The central electronic unit 11 comprises a server 110 to which at least a support for storage of data and programs is associated.

The usual peripheral units are connected to the server 110, which units enable an operator to interact with the server 110 itself, in the example a monitor 111, a keyboard 112 and a mouse 113.

The remote connection between the central electronic unit 11 and the electronic terminals 21 can be realised via the internet, with the use of the usual connecting means therefor (modem, router, etc.).

The connection is preferably protected, such that the data exchange can be made exclusively between the central electronic unit 11 located in the producing company 10 and the electronic terminals 21 located in the boutiques 20, thus forming a web space internally of the marketing network.

A database is stored in the server storage unit 110, which database contains the whole collection of products realised and put up for sale by the producing company 10, among which articles of clothing and the like, such as for example shoes, handbags, hats and other and various accessories.

The database also contains data relating to the constructional characteristics of the various products, the modes of use thereof, and the available assortment of the products.

The expression “constructional characteristics” relates for example to the data relating to the materials used, the chemical-physical properties of the materials themselves, the manufacturing modes and the like.

The expression “modes of use” relates for example to the data relating to the dressability of the articles of clothing, how to wear them, climatic situations or conditions to which the article of clothing is most suited, and the like.

The term “assortment” relates to the available sizes, colours and variants of a same article of clothing.

The database is constructed such as to correlate each product with one or more further products from the database which can be combined with the product under scrutiny, in order to obtain a pleasant or at least original composition.

Each combination is preferably designed by one or more expert company stylists, and is then stored on the data base.

The database is further constructed such as to correlate each product with the relative information inherent to the constructional characteristics thereof, as well as with the information relating to the modes of use and the assortment of the product.

The products contained in the database, as with all the data inherent thereto, can be inserted, modified, removed or replaced at any moment via the central electronic unit 11.

In this way, the products and the relative information contained in the database can be updated whenever a new collection is presented, or when a new product is marketed or when a certain product's availability changes, or for any other reason.

The memorisation unit of the server 110 also stores a computer program which, when the server 110 runs it, manages the data contained in the database and transfers the data between the central electronic unit 11 and the various electronic terminals 21.

In particular, the computer program is programmed to enable the central electronic unit 11 to receive, from each electronic terminal 21, a query signal associated to at least a product contained in the database, to search the database for further products which might be combined with the product associated to the query signal, and to transmit a response signal associated to the further products to the electronic terminal 21 from which the query signal emanated.

In this way, the electronic terminal 21 present in each boutique 20 enables the system to be consulted in order to obtain real-time advice on combinations, total look and style, all of which have been directly designed by the expert stylists working for the producing company.

The computer program is also programmed to enable the central electronic unit 11 to search the database for information relating to the constructional characteristics and/or the modes of use and/or the assortment of the product associated to the query signal, and to transmit a response signal associated to each of the data units to the electronic terminal 21 from which the query signal originated.

In this way, each electronic terminal 21 enables the respective users to remain updated on the products in the collection.

In particular the electronic terminals 21 can be used by both sales staff employed in the various boutiques 20 and directly by potential customers visiting the boutiques 20.

In this way, the system can have a double function, i.e. a training and constant updating function and/or a virtual assistance function in buying, which can be added-to or even can replace the sales personnel.

In a preferred aspect of the invention, the computer program is also programmed to enable the central electronic unit 11 to generate a buying order for the product associated to the query signal coming from one or more of the electronic terminals 21.

The buying order will then be managed according to the specific modes used by the producing company 10 in online dealing, for example by subordinating acceptance of payment of the price due via credit cards, and a subsequent dispatch of the product directly to the customer's home.

To this end, one or more electronic terminals 21 can be equipped with a POS, i.e. any automatic apparatus enabling payments to be accepted via bank cash cards (ATM cards), credit cards, debit cards, pre-paid credit cards and the like.

In this way the system completely replaces the sales personnel, enabling a customer not only to select the product but also to acquire the selected product.

This aspect of the invention enables completely automatic boutiques 20 to be created, without staff and provided only with an electronic terminal 21, for example located in an airport.

In a further aspect of the invention, the central electronic unit 11 and one or more electronic terminals 21 can be provided with means necessary for realising a video-conferencing communication.

The means comprise both the hardware devices (webcam, microphones, loudspeakers, etc.) and the software applications required for an effective real-time exchange of images and sounds between the central electronic unit 11 and the electronic terminals 21.

This embodiment is particularly useful for training boutique 20 staff, as it enables a distance updating course to be organised in which a single relater located at the central electronic unit 11 can teach a group of users who are located at the various electronic terminals 21.

Obviously a technical expert in the sector might make numerous modifications of a technical-applicational nature to the invention as described herein above, without its forsaking the ambit of protection of the invention as claimed herein below.

1. A method for presenting articles of clothing and/or the like at sales points (20) of a commercial network, comprising steps of predisposing a plurality of electronic terminals (21) in various sales points (20), remotely connecting the electronic terminals (21) to a central electronic unit (11), creating a database of the products which database can be modified via the central electronic unit (11), and running, on a computer, a processing program which enables the central electronic unit (11) to receive, from each electronic terminal (21), a query signal associated with at least a product in the database, locating in the database one or more further products which can be combined with a product associated to the query signal, and transmitting a response signal associated with the further products to the electronic terminal (21) from which the query signal originated.

2. The method of claim 1, wherein the processor program further enables the central electronic unit (11) to locate data in the database which data relates to constructional characteristics of the product associated to the query signal, and to transmit a response signal associated to the data to the electronic terminal (21) from which the query signal originated.

3. The method of claim 1, wherein the processor program further enables the central electronic unit (11) to locate data in the database which data relates to modes of use of the product associated to the query signal, and to transmit a response signal associated to the data to the electronic terminal (21) from which the query signal originated.

4. The method of claim 1, wherein the processor program further enables the central electronic unit (11) to locate data in the database which data relates to an assortment of the product associated to the query signal, and to transmit a response signal associated to the data to the electronic terminal (21) from which the query signal originated.

5. The method of claim 1, wherein the processor program further enables the central electronic unit (11) to generate a buying order for the product which buying order is associated to the query signal.

6. The method of claim 1, comprising a step of realising a video-conferencing communication via the central electronic unit (11) and at least an electronic terminal (21).

7. An apparatus for presenting clothing products and/or the like at sales points (20) of a commercial network, comprising a plurality of electronic terminals (21) located in the various sales points (20), a central electronic unit (11) remotely connected to the electronic terminals (21), a database of the products which can be modified via the central electronic unit (11), and a processing program which, when run on a computer, enables the central electronic unit (11) to receive from each electronic terminal (21) a query signal which is associated to at least a product in the database, to locate one or more further products in the database which can be combined with the articles associated to the query signal, and to transmit a response signal associated to the further products to the electronic terminal (21) from which the query signal originated.

8. The apparatus of claim 7, wherein the processing program is programmed such that when run on a computer it further enables the central electronic unit (11) to locate data in the database which data relates to constructional characteristics of the product associated to the query signal, and to transmit a response signal associated to the data to the electronic terminal (21) from which the query signal originated.

9. The apparatus of claim 7, wherein the computer program is programmed such that when run on a computer it further enables the central electronic unit (11) to locate data in the database which data relates to modes of use of the product associated to the query signal, and to transmit a response signal associated to the data to the electronic terminal (21) from which the query signal originated.

10. The apparatus of claim 7, wherein the computer program is programmed such that when run on a computer it further enables the central electronic unit (11) to locate data in the database which data relates to an assortment of the product associated to the query signal, and to transmit a response signal associated to the data to the electronic terminal (21) from which the query signal originated.

11. The apparatus of claim 7, wherein the computer program is programmed such that when run on a computer it further enables the central electronic unit (11) to generate a buying order for the product associated to the query signal.

12. The apparatus of claim 7, comprising means for realising a video-conferencing communication via the central electronic unit (11) and at least an electronic terminal (21).

13. The apparatus of claim 7, wherein at least an electronic terminal of the electronic terminals (21) is equipped with a POS device.
